(19) United States
(12) Patent Application Publication
(10) Pub. No.: US 2010/0291883 A1
(43) Pub. Date: Nov. 18, 2010

(54) METHOD AND APPARATUS FOR ACTIVATING AN EMERGENCY BUTTON IN A PORTABLE RADIO

(75) Inventors: Chee Peng LIM, Ipoh (MY); Ai Ying Lim, Nibong Tebal (MY)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 12/466,052

(22) Filed: May 14, 2009

(51) Int. Cl. H04B 1/38

(52) U.S. Cl. 455/90.2

(57) ABSTRACT

The application discloses a method and apparatus for activating an emergency button on a portable radio. The emergency button is located on a portion of the portable radio that can be hit against a substantially hard surface by a user to transmit an emergency alert signal. Activation of the alert can further include pressing a push-to-talk (PTT) switch in conjunction with hitting the portion of the portable radio having the emergency button.

### FIELD OF THE DISCLOSURE

The present disclosure relates generally to a portable radio and more particularly to a method and apparatus for activating an emergency button in the portable radio.

### BACKGROUND

A portable radio, such as a two-way hand-held radio used in the public safety environment, includes an emergency button that is used for activating an emergency alert in an emergency situation. The emergency button is typically small in size and positioned on a top surface of the portable radio amongst a variety of switches, knobs and antenna. Users of public safety devices, such as fire fighters, police officers, rescue members etc., often wear gloves and other safety equipment that can make it difficult to depress or access the emergency button located adjacent to other knobs or switches. Safety gloves in particular tend to be large in size and can impede the user's sensitivity to detect the emergency button. In some instances, the user of the portable radio may not be able to remove his safety gloves to access the emergency button due to surrounding environmental conditions.

The challenge in designing the ergonomics for a portable public safety product includes providing maximum functionality in tight size constraints with an easily accessible user interface.

Accordingly, there exists a need for an emergency button in the portable radio that overcomes the aforementioned challenges.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a communication system in accordance with some embodiments.

FIG. 2 is a portable radio in accordance with some embodiments.

FIG. 3 is a block diagram of the portable radio in accordance with some embodiments.

FIG. 4 is a flowchart representing a method for activating an emergency button in the portable radio in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method, steps and components related to activating an emergency button in a portable radio. The present disclosure is directed towards a method and apparatus for activating an emergency button in the portable radio. The method includes activating the emergency button by hitting at least a portion of the portable radio having the emergency button against a surface. Embodiments will be described that further include depressing a push-to-talk (PTT) switch while hitting the portable radio portion having the emergency button.

In the description herein, numerous specific examples are given to provide a thorough understanding of various embodiments of the invention. The examples are included for illustrative purpose only and are not intended to be exhaustive or to limit the invention in any way. It should be noted that various equivalent modifications are possible within the spirit and scope of the present invention. One skilled in the relevant art will recognize, however, that an embodiment of the invention can be practiced with or without the apparatuses, systems, assemblies, methods, components mentioned in the description.

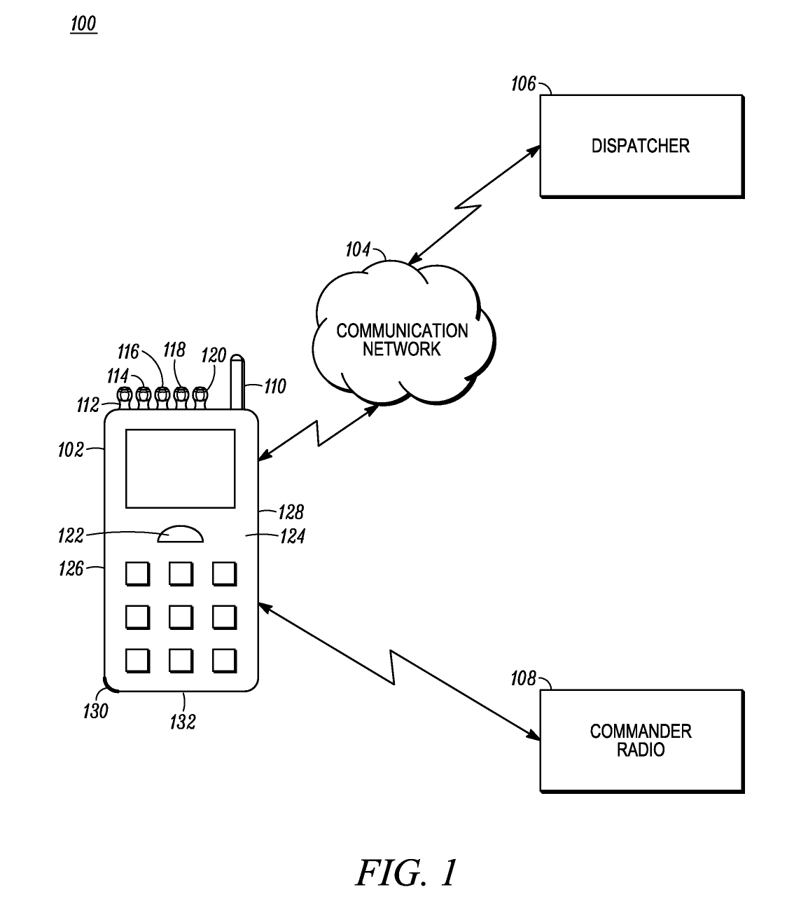

FIG. 1 illustrates a communication system 100 in accordance with some embodiments. The communication system 100 includes a portable radio 102, a communication network 104, a dispatcher 106, and a commander radio 108 associated with a command station.

In accordance with an embodiment, the portable radio 102 is communicatively coupled to the dispatcher 106 and the commander radio 108. The portable radio 102 may be any device that is designed to receive, decode, and transmit radio signals. The radio signals may be transmitted and received from the dispatcher 106 or any other portable radios, e.g. commander radio 108. Further, the portable radio 102 is a hand-held product carried by a user to communicate with others. The portable radio 102 includes an antenna 110 and a plurality of knobs, switches and programmable buttons such as volume control 112, channel change 114, zone selector (A, B, C) 116, scan/clear 118, and repeater/direct 120. A push-to-talk (PTT) switch 122 may be located at front surface 124 or alternatively at either side surface 126 or 128.

In accordance with the embodiment, the portable radio 102 may be used to generate an emergency alert in case of an emergency situation, such as fire, rescue operation etc. The portable radio 102 includes an emergency button 130 positioned such that an emergency alert can be generated by hitting a portion of the portable radio 102 having the emergency button 130 against a surface that is strong enough to depress the emergency button 130. In this embodiment, emergency button 130 is located on one corner of the portable radio 102 along side surface 126 and bottom surface 132.

In accordance with the embodiment, the communication network 104 is any wireless network known in art that can be used to connect communication devices such as portable radio 102 and other terminals over large or small geographical distances. For example, the communication network 104 connects the portable radio 102 to the dispatcher 106.

In accordance with the embodiment, the dispatcher 106 refers to a communications personnel responsible for receiving and transmitting messages, tracking vehicles and equipment, and recording other important information. For example, a number of organizations, including police and fire departments, emergency medical services, and public utility companies, use dispatchers to relay information and coordinate their operations.

In accordance with the embodiment, the dispatcher 106 receives an emergency signal that includes an emergency identification number of the portable radio 102 in case of the emergency situation. The emergency identification number is utilized to determine a geographical location of the portable radio 102. For example, position/location of a firefighter using the portable radio 102.

In accordance with the embodiment, the commander radio 108 at the command station is connected to the portable radio 102 via a wireless link. The commander radio 108 receives an emergency identification number of the portable radio 102 in case of the emergency situation. The emergency identification number is utilized by the commander associated with the commander radio 108 to determine a geographical location of the portable radio 102. In one embodiment, the commander radio 108 may be directly connected to a portable radio 102 using any of a variety of communication technologies.

Other embodiments may include depressing the PTT switch 122 in conjunction with hitting the emergency alert button 130. Depressing the PTT switch 122, while activating the emergency button, avoids false alerts.

In one embodiment, the emergency button 130 is activated by hitting a portion of the portable radio 102 having the emergency button 130, at least twice against a surface without pressing the PTT switch 122. The portion of the portable radio 102 is hit at least twice within a predetermined time interval so that the emergency button 130 is activated and triggers the emergency alert. Thus, the emergency button 130 is activated and the emergency alert is triggered by hitting or smacking the portion of the portable radio 102 having the emergency button 130 against any surface that is strong enough to depress the emergency button.

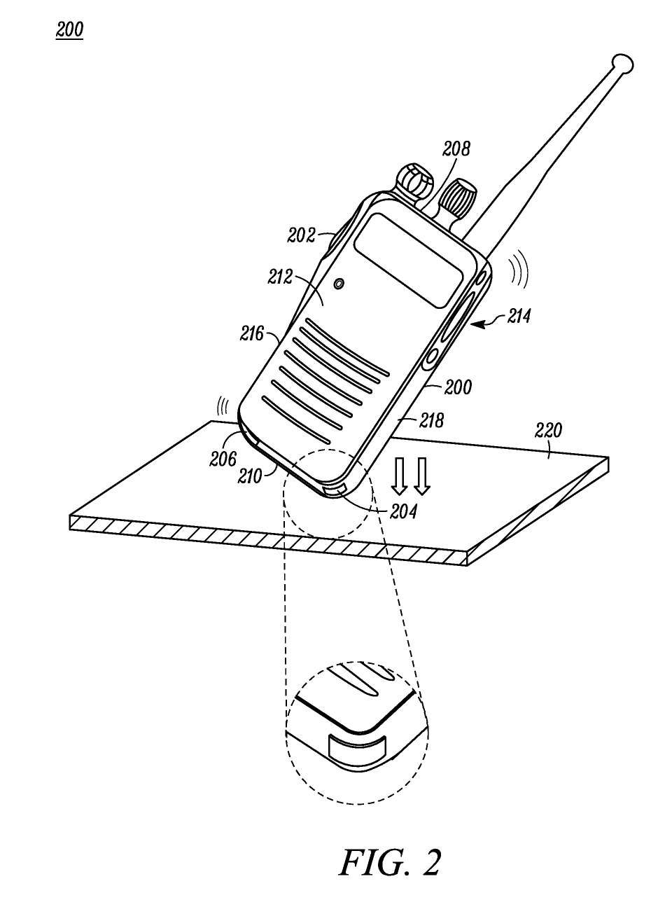

FIG. 2 illustrates a portable radio 200 in accordance with some embodiments of the invention. The portable radio 200 includes housing, a push-to-talk (PTT) switch 202, and emergency buttons 204, 206. The PTT switch 202 is large enough to be accessed by a gloved hand and located on a side surface 216.

In accordance with an embodiment, the housing comprises of a plurality of surfaces that form an outer casing of the portable radio 200. The plurality of surfaces include a top surface 208, a bottom surface 210, a front surface 212, a back surface 214, and a left side surface 216 and a right side surface 218. The left side surface 216 includes the PTT switch 202 that is used for transmitting the user's voice and possibly data. The top surface 208 includes an antenna and a plurality of control knobs and switches. The PTT switch 202 provides a user interface of sufficient size for a gloved hand to access. In this embodiment, two emergency buttons 204, 206 are located on portions of the portable radio 200 that can be hit against a hard surface 220.

In accordance with an embodiment, emergency buttons 204, 206 are positioned on a bottom right corner portion 210/218 and a bottom left corner portion 210/216 of the portable radio 200 respectively. The emergency buttons 204, 206 can be tactile switch, an LED illuminated push button, a dual-LED push button, or a pressure sensitive switch button. The emergency buttons 204, 206 act as panic buttons to call for help. It should be noted that the emergency buttons 204, 206 may be of any type that can be activated by hitting a hard surface. The emergency buttons 204, 206 may be positioned at any portion or surface of the portable radio 200 that will allow the buttons to be activated when the portion of the radio having the buttons is hit against a hard surface. Thus, for the embodiments shown in FIGS. 1 and 2, the emergency buttons 130, 204, 206 could be placed on any surface except the top surface where the plurality of radio control knobs, switches and antenna are located. For example, the emergency buttons 204, 206 may be located at a corner portion, a bottom portion 210, a front portion 212, a back portion 214, or a side portion 216, 218 of the portable radio 200.

In accordance with another embodiment, the emergency buttons 204, 206 may be located on a portion of the bottom surface of the housing when the PTT switch 202 is located on the left side surface of the housing or the right side surface of the housing. In embodiments that depress the PTT switch 202 in conjunction with hitting the emergency button 204 or 206, the positions of the emergency buttons 204, 206 should be offset from the PTT switch 202. It should be noted that the left side surface 216 may be referred as first side surface and the right side surface 218 as the second side surface in the below description.

Operationally, in case of an emergency situation, the user of the portable radio 200 activates one of the emergency buttons 204 or 206 by hitting a portion of the portable radio 200 having the emergency buttons against a surface, for example, a wall, a floor, a table etc. The emergency buttons 204, 206 are positioned in the portable radio 200 in such a way that when the user hits either one of the emergency buttons 204, 206 an emergency alert is triggered. In one embodiment, hitting of the portable radio 200 may include smacking, tapping, banging the portable radio 200 against the surface.

In accordance with the embodiment, when the portable radio 200 is hit against a surface, an emergency alert is triggered through a pre-programmed channel. Triggering the emergency alert includes transmitting an emergency signal including the emergency identification number of the portable radio 200 over the pre-programmed channel. The pre-programmed channel can be any frequency channel through which the emergency signal is transmitted to the commander radio 108 or to the dispatcher 106.

In accordance with the embodiment, the emergency signal is transmitted to a dispatcher or a dispatch station or another portable radio so that the portable radio that triggered the emergency can have priority to talk first among all the members in a same talk group for a period of time.

In accordance with the embodiment, the emergency alert transmits real-time audio information surrounding the portable radio 200 over a pre-programmed channel associated with the portable radio 200. In one embodiment, the transmission of the real-time audio information is independent of depressing the PTT switch 202. In other words, the real-time audio information is transmitted to a dispatch station or a dispatcher 106 or another portable radio without the need of PTT switch 202 being depressed.

In accordance with an embodiment, emergency alert is generated in response to the portion of the portable radio 200 having at least one of the emergency buttons 204, 206 being hit while depressing the PTT switch 202, so that there is no false activation of the emergency buttons 204, 206. In other words, the false alarms triggered unintentionally by simply hitting emergency button 204, 206 alone are avoided.

In accordance with another embodiment, the emergency signal is generated by hitting a portion of the portable radio 200 having the emergency buttons 204, 206 at least twice against a surface. The portion of the portable radio 200 is hit at least twice within a predetermined time interval. The predetermined time interval can be a particular time period within which portion of the portable radio 200 must be hit against a surface in order to generate the emergency alert signal.

Thus, an emergency alert is generated when the emergency button 204, 206 is hit either twice against a surface or the emergency button 204, 206 is hit against a surface while the PTT switch 202 is being depressed.

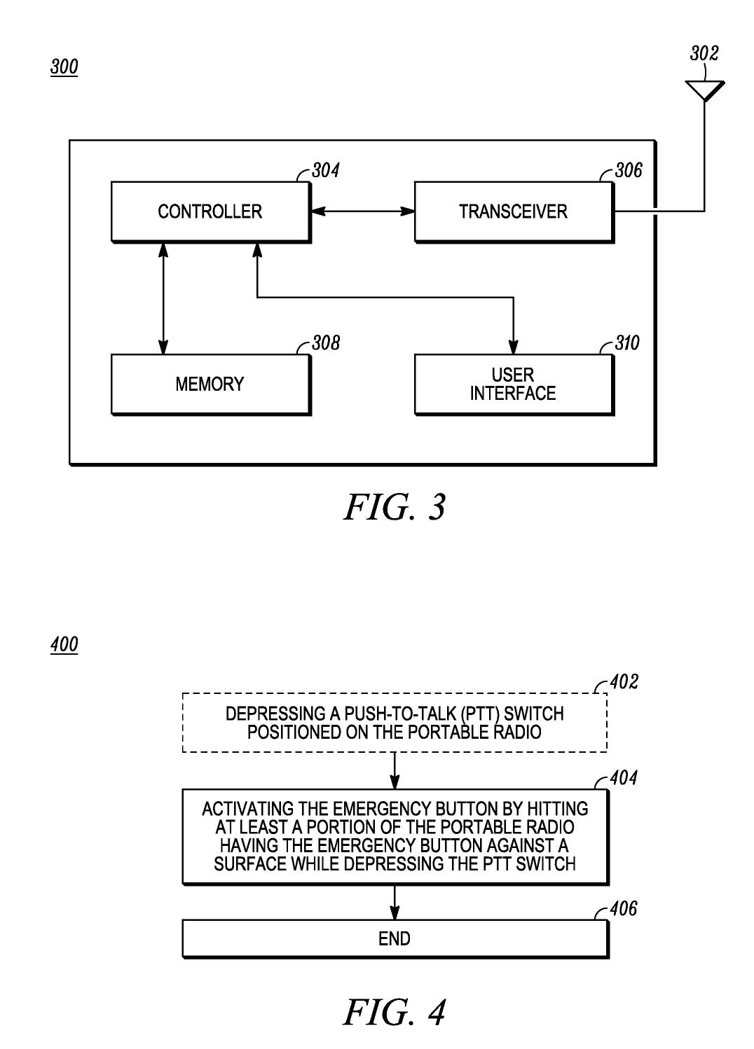

FIG. 3 is a block diagram illustrating the internal components of a portable radio 200 in accordance with some embodiments of the invention. The exemplary components include an antenna 302, a controller 304, a transceiver 306, a memory 308, and a user interface 310. The user interface 310 includes emergency buttons 204, 206.

In accordance with the embodiment, the antenna 302 comprises any known or developed structure for radiating and receiving electromagnetic energy in the frequency range containing the wireless carrier frequencies. The antenna 302 is used for transmitting radio signal over a pre-programmed channels allocated to the portable radio in an emergency situation. In another embodiment, the pre-programmed channels may be allocated for PTT communication.

In accordance with the embodiment, the transceiver 306 coupled to the controller 304 enables the portable radio 200 to transmit and receive the RF signals through the antenna 302. In accordance with the embodiment, the transceiver 306 converts the RF signals received from the antenna 302 to digital data for use by the controller 304.

In accordance with the embodiment, the controller 304 is coupled to the transceiver 306, the memory 308, and the user interface 310. The controller 304 operates in conjunction with the data and instructions stored in the memory 308 to control the operation of the portable radio 200. The controller 304 may be implemented as a processor, a digital signal processor, hard-wired logic and analog circuitry, or any suitable combination of these.

In accordance with the embodiment, the memory 308 is coupled to the controller 304 to store data and instructions for the operation of the controller 304 The memory 308 maintains a database that stores the information about the pre-programmed channels that can be used by the portable radio 200, available dispatch stations or dispatcher 106 and the other portable radios involved in a same talk group.

In accordance with the embodiment, the user interface 310, coupled to the controller 304, is used for determining whether the emergency button 204, 206 is depressed, and accordingly sending a control signal to the controller 304. When the portion of the portable radio 200 having at least one of the emergency button 204, 206 is hit against the surface, the user interface 310 senses the depressing action of the emergency button 204, 206. Further, the user interface 310 sends the control signal to the controller 304 indicating that the emergency button 204, 206 is activated by the user.

Operationally, during emergency situation, the user associated with the portable radio 200 hits the emergency portion of the portable radio 200 against a surface for triggering an emergency alert. The emergency buttons 204, 206 being part of the user interface 310 that is coupled to the controller 304, senses that one of the emergency button 204, 206 is depressed and sends the control signal to the controller 304 indicating that the emergency button 204, 206 is activated by the user. Upon receiving the control signal, the controller 304 obtains information of the available pre-programmed channel from the memory 308, and triggers emergency alert by transmitting an emergency signal over the pre-programmed channel to the receiving device such as the dispatcher 106, commander radio 108, or any other portable radios. The emergency signal includes an emergency identification number that is later utilized by the receiving device to determine the geographical location and other related information of the portable radio 200 and the user associated with the portable radio 200.

FIG. 4 is a flowchart of a method for activating an emergency button 204, 206 in accordance with some embodiments. Referring to FIG. 4, the method 400 begins with a step of depressing 402 a push-to-talk (PTT) switch 202 positioned on the portable radio 200. It may be noted that the step of depressing 402 may be eliminated for the embodiments not requiring PTT switch 202 to be depressed.

Upon depressing the PTT switch 202, the method 400 then moves to step of activating 404 the emergency button 204, 206 by hitting at least a portion of the portable radio 200 having the emergency button 204 or 206 against a surface while depressing the PTT switch 202. In one embodiment, activating the emergency button 204, 206 may trigger an emergency alert that includes transmitting an emergency signal including an emergency identification number of the portable radio 200 over a pre-programmed channel associated with the portable radio 200. In another embodiment, the emergency alert may include transmitting real-time audio information surrounding the portable radio 200 over the pre-programmed channel associated with the portable radio 200 when at least one of the emergency button 204, 206 is hit in conjunction with depressing the PTT switch.

Thus, the user of the portable radio, e.g. a fire fighter does not require removing his gloves to activate the emergency button. Also, the user need not search or locate for a small emergency button on the portable radio. Depending on the embodiment used, a portable radio may simply be hit against a surface to activate an emergency alert located on that surface.

In alternate embodiment, the user of the portable radio depresses the PTT switch and hits the portable radio against a surface like a wall, floor, a table top, or even user's thighs in order to activate the emergency button whenever there is an emergency situation. The method and apparatus provided by the emergency buttons is exceptionally useful when the user, for example, fire fighter is crawling in the smoke-filled room. By relocating the emergency button to a non-crowded surface, away from the control knobs, switches and antenna, an improved user interface has been provided that facilitates user access to an emergency alert on a portable radio. The placement of the switch to a surface of the portable product that can be hit eliminates the need for removal of any equipment by the user.

In the foregoing specification, specific embodiments have been described. The benefits of the emergency alert include ease of access in the tender environmental conditions where the visibility is difficult and where the user's hands are encumbered by the heavy gloves. Additionally, moving the alert button to other surfaces of the radio leaves the top surface with more space with which to manipulate the other control knob switches. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized controllers (or “controlling devices”) such as microcontroller, customized controllers and unique stored program instructions (including both software and firmware) that control the one or more controllers to implement, in conjunction with certain non-controller circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject

Those skilled in the art will appreciate that the above recognized advantages and other advantages described herein are merely exemplary and are not meant to be a complete rendering of all of the advantages of the various embodiments of the present invention.

We claim:

1. A portable radio comprising:
a push-to-talk (PTT) switch; and
at least one emergency button positioned on the portable radio, the at least one emergency button is activated by hitting at least a portion of the portable radio having the emergency button against a surface while depressing the PTT switch.

2. The portable radio of claim 1, wherein the emergency button includes at least one of a tactile switch, a LED illuminated push button, a dual-LED push switch, a pressure sensitive switch button, and a toggle switch.

3. The portable radio of claim 1, wherein the portion of the portable radio having the emergency button includes at least one of a corner portion, a bottom portion, a front portion, a back portion, and a side portion of the portable radio.

4. The portable radio of claim 1, wherein the emergency button triggers an emergency alert.

5. The portable radio of claim 4, wherein the emergency alert comprises transmitting an emergency signal including an emergency identification number of the portable radio over a pre-programmed channel associated with the portable radio.

6. The portable radio of claim 5, wherein the emergency identification number is utilized to determine a geographical location of the portable radio.

7. The portable radio of claim 5, wherein the emergency signal is transmitted to at least one of a dispatch station, a portable radio, over a pre-programmed channel associated with the portable radio.

8. The portable radio of claim 4, wherein the emergency alert further comprises transmitting real-time audio information surrounding the portable radio over the pre-programmed channel associated with the portable radio.

9. The portable radio of claim 8, wherein transmitting the real-time audio information is independent of depressing the PTT switch.

10. The portable radio of claim 4, wherein the emergency alert is generated in response to the portion of the radio having the emergency button being hit while depressing the PTT switch, thereby preventing false triggering of the emergency button.

11. A portable radio comprising:
at least one emergency button positioned on the portable radio, the at least one emergency button is activated by hitting a portion of the portable radio having the emergency button, at least twice against a surface.

12. The portable radio of claim 11, wherein the emergency button triggers an emergency alert.

13. The portable radio of claim 11 further comprising a plurality of control features and an antenna on a top surface of portable radio and wherein the at least one emergency button is located on a surface other than the top surface.

14. The portable radio of claim 12, wherein the emergency alert is generated in response to the portion of the radio having the emergency button being hit at least twice, thereby preventing false triggering of the emergency button.

15. The portable radio of claim 11, wherein the portion of the radio is hit at least twice within a predetermined time interval.

16. A method for activating an emergency button in a portable radio, the method comprising:
depressing a push-to-talk (PTT) switch positioned on the portable radio; and
activating the emergency button by hitting at least a portion of the portable radio having the emergency button against a surface while depressing the PTT switch.

17. The method of claim 16, wherein at least the portion of the portable radio is hit against the surface for triggering an emergency alert.

18. The method of claim 17, wherein the emergency alert transmits an emergency signal including an emergency identification number of the portable radio over a pre-programmed channel associated with the portable radio.

19. The method of claim 18, wherein the transmitted emergency identification number is utilized to determine a geographical location of the portable radio.

20. The method of claim 18, wherein the emergency signal is transmitted to at least one of a dispatch station, a portable radio, over a pre-programmed channel associated with the portable radio.

21. The method of claim 18, further comprises transmitting real-time audio information surrounding the portable radio over the pre-programmed channel associated with the portable radio.

22. The method of claim 17, wherein the emergency alert is generated in response to the portion of the radio having the emergency button being hit while depressing the PTT switch, thereby preventing false triggering of the emergency button.

23. A portable radio, comprising:
a housing having a plurality of surfaces;
a push-to-talk (PTT) switch located on a surface of the plurality of surfaces of the housing;
an emergency alert button located on another surface of the housing, the emergency alert button being activated in response to a user pressing the PTT switch in conjunction with hitting the another surface having the emergency alert button onto an external surface

24. The portable radio of claim 23, wherein the emergency alert button protrudes from the housing.

25. The portable radio of claim 23, wherein a predetermined minimum number of hits is required to activate the emergency alert button.

26. The portable radio of claim 23, wherein the plurality of surfaces of the housing comprise:
top, bottom, front, back and first and second side surfaces, and wherein the PTT switch is located on the first side surface and the emergency alert button is located on at least a portion of the bottom surface of the housing.

27. The portable radio of claim 23, wherein the PTT switch is located on the front surface of the housing and the emergency alert button is located on at least the portion of the bottom surface of the housing.
